(19) United States
(12) Patent Application Publication
(10) Pub. No.: US 2009/0208711 A1
(43) Pub. Date: Aug. 20, 2009

(54) METHOD FOR MAKING AN OBJECT FROM A PAPER PROJECT AND OBJECT FORMED

(76) Inventor: Sachiko Iwasaki, Madison, WI (US)

Correspondence Address: LATHROP & CLARK LLP, 740 REGENT STREET SUITE 400, P.O. BOX 1507, MADISON, WI, 537011507, US

(21) Appl. No.: 11/577,492

(22) PCT Filed: Oct. 21, 2005
(86) PCT No.: PCT/US05/38061

§ 371 Date: Apr. 18, 2007

(30) Foreign Application Priority Data
Oct. 22, 2004 (JP) 2004-307526

(51) Int. Cl. B32B 7/14; B32B 3/30; B32B 38/00

(52) U.S. Cl. 428/201; 428/162; 156/205

(57) ABSTRACT

A paper-constructed object usable to form a high strength structure is itself formed using a fiber-powder paper product. The fiber-powder paper product is formed from a biodegradable plastic base material and fiber-powder surface coating material. The fiber-powder surface coating material is applied to at least one surface of the biodegradable plastic base material. The paper-constructed object includes a top sheet, a middle sheet and a bottom sheet of the fiber-powder paper. The middle sheet has a plurality of projections formed in it. The projections can be pyramidal, with a square base and side surfaces that are equilateral triangles. The plurality of equilateral 4-sided pyramidal projections are contiguous and extend between the top and bottom sheets. The four base edges of the equilateral 4-sided pyramidal projections are bonded to the bottom sheet and the tips of the equilateral 4-sided pyramidal projections are bonded to the top sheet.

### FIELD OF THE INVENTION

This invention relates to a method for making objects from a paper product that incorporates agricultural, forestry and/or recycled paper fiber powders, and objects formed of such paper using such methods.

### RELATED ART

Paper products that use fiber powders obtained from agricultural and/or forestry materials and/or recycled paper products are disclosed in Japanese Patent Publication 2004-504176 and U.S. Published Patent Application 2004-0040680, each of which is incorporated herein by reference in its entirety. This paper product has a biodegradable plastic base material and a fiber-powder surface coating material formed on the base material. The fiber-powder surface coating material includes fiber powders obtained from agricultural and/or forestry materials and/or recycled paper products.

As disclosed in the incorporated references, this paper product is formed by powdering fibers obtained from the agricultural and/or forestry materials and/or recycled paper products. The fiber-powder material, even though formed from a fibrous material, is no longer “fibrous”, in that the fibers in the material are not able to mechanically or frictionally interlink. In various exemplary embodiments, the fiber-powder material is attached to the biodegradable plastic substrate using an adhesive vegetable liquid. The adhesive vegetable liquid can be applied to the substrate before or after applying the fiber-powder and/or can be mixed with the powdered plant material before the mixture is applied to the plastic substrate.

In particular, the base agricultural and/or forestry materials and/or recycled paper products are selected for use based on their ability to absorb water or the adhesive vegetable juice, rather than on their fibrous nature. In contrast, traditional paper products are formed using plant fibers, such as wood, cotton, linen, flax and/or other plant fibers. These traditional paper products are formed as a web or felt of the plant fibers, and gain their strength from the internal tensile strength of the individual fibers and from the frictional and mechanical interactions between the various fibers in the web or felt. In particular, the tensile strength of such traditional papers is due in large part to the directionality of the fibers.

This type of paper product can be made to be resistant to water and/or oils to at least some extent through a manufacturing process. This type of paper can also be manufactured to not be permeable by air or water.

### SUMMARY OF THE INVENTION

However, the paper product disclosed in the incorporated references is difficult to use as a material for a material packing box or the like for a variety of reasons. For example, when compared to traditional fiber-based paper that is commonly used in cardboard boxes and the like, this fiber-powder paper product is weaker when subjected to lateral stresses, as it cannot rely on the tensile strength the plant fibers provide to such traditional fiber paper products.

It should also be appreciated that the fiber-powder paper product disclosed in the incorporated references, depending on how it is formed, can be very flexible or quite rigid. In particular, in various exemplary embodiments, when the fiber-powder material is bonded to the biodegradable plastic substrate using an adhesive vegetable juice, such as slime juice, without applying any heat, the fiber-powder paper product remains soft and flexible, even after the vegetable juice dries. In contrast, if the fiber-powder paper product is heat-treated after the fiber-powder material is applied, or as part of that process, the strength, rigidity, and/or hardness of the fiber-powder paper product increases significantly.

This invention provides systems and methods for forming a sheet of fiber-powder paper product into a three-dimensional product or object.

This invention separately provides systems and methods for forming a sheet of fiber-powder paper into a three-dimensional construct and for combining that sheet with top and bottom additional sheets to form a three-dimensional fiber-powder sheet object.

This invention separately provides systems and methods for deforming a sheet of fiber-powder paper into a three-dimensional form.

This invention separately provides systems and methods for deforming a sheet of fiber-powder paper into a three-dimensional construct having pyramidal projections.

This invention separately provides systems and methods for forming a sheet of fiber-powder paper.

This invention separately provides systems and methods for casting a sheet of fiber-powder paper in a three-dimensional form.

This invention separately provides a paper-construction objection product comprising a top and bottom sheet of fiber-powder paper and an interposed three-dimensional sheet of fiber-powder paper.

In various exemplary embodiments of systems and methods according to this invention, a sheet of fiber-powder paper is formed by bonding or adhering a fiber-powder obtained from agricultural and/or forestry material and/or recycled paper material to at least one side of a biodegradable plastic substrate. In various exemplary embodiments, the fiber-powder material is bonded or adhered to both sides of the biodegradable plastic substrate. In various exemplary embodiments, the fiber-powder material is bonded or adhered to the biodegradable plastic substrate by spraying a mist of moisture, such as water, onto the appropriate surface(s) of the biodegradable plastic substrate. Subsequently, the fiber-powder material is sprayed onto the moistened surface of the biodegradable substrate. A suitable amount of heat is then added to bond or adhere the fiber-powder material to the biodegradable substrate. In various exemplary embodiments, rather than using water to form the mist of moisture, a vegetable juice can be used instead. In various exemplary embodiments, the vegetable juice is a viscous, filmy vegetable liquid. In various exemplary embodiments, the vegetable juice is a vegetable slime juice.

In various other exemplary embodiments, the fiber-powder paper product is formed by mixing the fiber-powder obtained from agricultural and/or forestry materials and/or recycled paper products with fibers formed of the biodegradable plastic. In various exemplary embodiments, the mixture is spread out onto a form and dried to form the fiber-powder paper. In various exemplary embodiments, the form provides a three-dimensional shape to the sheet of powdered paper product. In various exemplary embodiments, the form or mold has raised projecting areas, such that the resulting sheet of powdered paper material has raised projections which can be pyramidal shaped.

In various exemplary embodiments, a three-dimensional paper-constructed object or product is formed from a plurality of sheets of the fiber-powder paper according to this invention. In various exemplary embodiments, a center sheet is deformed by pressing raised areas into it. Subsequently, the tips of the raised deformations are attached such as by bonding, gluing or the like, to a first sheet of the fiber-powder paper, while the base edges of the raised deformations are attached, such as by bonding, gluing or the like to a second sheet of the fiber-powder paper.

In various exemplary embodiments, a first deformed sheet is attached by the tips of the pyramidal deformation to the first sheet of the fiber-powder paper, while a second deformed sheet is attached by the base edges of the to a second sheet of the fiber-powder paper. Thereafter, the two assemblies are combined by placing the first and second deformed sheets adjacent to each other such that the deformations in the second sheet extend into the areas between the deformations in the first sheet, along with some adhesive material between the two sheets. Thereafter, the adhesive material holds the four sheets securely together.

In various exemplary embodiments, the deformations are pyramidal. In various exemplary embodiments, the tips of the pyramidal deformations are modified to provide secondary bends into the sides of the pyramidal deformations. Similarly, in various exemplary embodiments, in addition to, or instead of, the bends formed near the tips of the pyramidal deformations, additional bends can be formed around the base edges of the pyramidal deformations.

In various exemplary embodiments, a viscous vegetable liquid can be included that bonds or adheres the fiber powder surface coating material to the biodegradable plastic substrate, and/or bonds or adheres the middle layer or sheet of fiber-powder paper to at least either one of the upper layer or sheet and/or the lower layer or sheet of the fiber-powder paper.

In various exemplary embodiments, the biodegradable plastic substrate has an upper surface and a lower surface, and the fiber-powder surface coating material can be applied to each of the upper surface and the lower surface.

In various exemplary embodiments, the agricultural and/or forestry materials can include one or more of sugar cane, hemp, kenaf, corn stalk, cotton seed shell, corn leaf, corn husk, wheat, straw, pineapple leaf, banana stem, banana leaf, and/or hazel nut shell.

These and other features and advantages of various exemplary embodiments of systems and methods according to this invention are described in, or are apparent from, the following detailed description of various exemplary embodiments of the systems and methods according to this invention.

### BRIEF DESCRIPTION OF THE DRAWINGS

Various exemplary embodiments of the systems and methods of this invention will be described in detail, with reference to the following figures, wherein:

FIG. 1 is a cross-sectional view of one exemplary embodiment of a fiber-powder paper product according to this invention;

FIG. 2 is a cross-sectional view of a first exemplary embodiment of a paper-constructed product or object formed from fiber-powder paper according to this invention;

FIG. 3 is a perspective view of a portion of one exemplary embodiment of the middle layer of the paper-constructed object shown in FIG. 3;

FIG. 4 is a cross-sectional view of a second exemplary embodiment of a paper-constructed object formed from fiber-powder paper according to this invention;

FIG. 5 is a cross-sectional view of a third exemplary embodiment of a paper-constructed object formed from fiber-powder paper according to this invention;

FIG. 6 is a cross-sectional view of a fourth exemplary embodiment of a paper-constructed object formed from fiber-powder paper according to this invention;

FIG. 7 is a top plan view of a first exemplary embodiment of an arrangement of the pyramidal projections formed in the middle layer of fiber-powder paper of the paper constructed object according to this invention;

FIG. 8 is a top plan view of a second exemplary embodiment of the arrangement of the pyramidal projections;

FIG. 9(a) is a side plan view of a set of rollers usable to form the middle layer of fiber-powder paper and of the paper constructed object according to this invention; and

FIG. 9(b) is a top plan view of the rollers shown in FIG. 9(a).

### DETAILED DESCRIPTION OF EXEMPLARY EMBODIMENTS

The following detailed description of various exemplary embodiments of systems, methods, constructions and structures according to this invention are described with respect to a sheet of paper product formed using a fiber-powder obtained from fibrous agricultural and/or forestry material and/or recycled paper products. It should be appreciated that, as used herein, the terms fiber-powder paper and fiber-powder material refers to materials and paper products formed using a fiber powder obtained from an agricultural material, a forestry material and/or recycled paper product material that does not rely on the frictional and/or mechanical interactions between fibers of the material(s). Accordingly, the term “fiber powder” can encompass purely powder materials as well as materials that include fibers, so long as the fibers are not relied upon to provide tensile or mechanical strength or to otherwise substantially mechanically or frictionally link together in the paper product.

The following detailed descriptions of fiber-powder paper products and objects constructed of such paper according to this invention describe objects that can be obtained even when using a paper product that is not necessarily strong, rigid or inflexible.

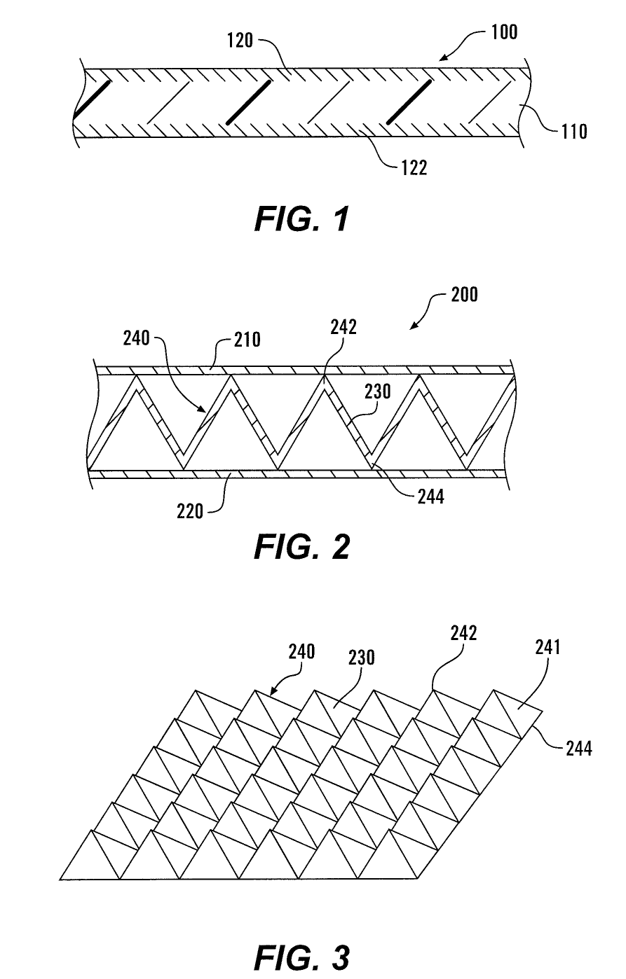

FIG. 1 is a cross-sectional view of one exemplary embodiment of a fiber-powder paper product according to this invention. The fiber-powder paper product discussed herein is similar to that disclosed in the incorporated references. The fiber-powder paper products shown in FIGS. 1-8 comprises a base material 1, a top layer of fiber-powder surface coating material 2, and a bottom layer of fiber-powder surface coating material 3.

The base material 1 comprises a biodegradable plastic that includes a non-oriented fiber cloth, such as felt. There are many biodegradable plastics based on a polysaccharide molecular structure, such as those with a fatty polyester resin structure or those having a polyvinyl alcohol structure, making it possible for various types of biodegradable plastics to be used when considering strength, resistance to chemicals or drugs, water resistance, and biodegradable properties at the time of disposal in nature. More precisely, Lacty (registered trademark), for example, of Shimatsu Manufacturing, Ltd., or Lactorone (registered trademark) of Kanebo, Ltd. can be used.

Further, the upper layer of the fiber-powder surface coating material 2 and the lower layer fiber-powder surface coating material 3 each comprises one or more agricultural and/or forestry derived fibers and/or recycled paper fibers, or the like. It should be appreciated that the agricultural and/or forestry derived fibers can be obtained from one ore more of sugar cane, hemp, kenaf, corn stalk, cotton seed shell, corn leaf, corn husk, wheat, straw, pineapple leaf, banana stem, banana leaf, or hazel nut shell. One of these agricultural and/or forestry derived fibers or a plurality of combinations of these agricultural and/or forestry derived fibers may be selected according to how the fiber-powder paper product is to be used. Furthermore, if recycled fiber is recycled from so-called virgin fiber, then virgin fiber may also be used. Even fibers and other suitable materials that are of low quality or have very little use, such as fins and pins left over from traditional paper making processes, may also be used in the fiber-powder surface coating materials.

In various exemplary embodiments, the fiber-powder paper product is made by spraying a mist of moisture onto the opposing surfaces of the base material 1. In various exemplary embodiments, the moisture is water. Thereafter, the fiber-powder surface coating material layers 2 and 3 are sprayed onto the opposing surfaces of the base materials. A suitable amount of heat may then be applied. By applying heat at a temperature that melts the base material 1 only slightly, the fiber-powder surface coating material layers 2 and 3 should bond well with the base material 1. Moreover, by adding heat, the water resistibility increases through the slight melting of the base material 1.

In various exemplary embodiments, in addition to or in place of the mist of moisture, a viscous, filmy vegetable liquid may also be applied to the base material 1. Viscous liquid derived from okra, the leaf of moroheiya, varieties of fenugreek, and the roots of tororoaoi are all types of viscous, filmy vegetable liquids. When using these types of viscous, filmy vegetable liquids, the viscous, filmy vegetable liquid functions as a bonding or adhesive agent for the fiber-powder surface coating materials 2 and 3. In such a case, it is not necessary to apply heat to bond or adhere the fiber-powder surface coating material layers 2 and 3. However, if improved water resistance is desired, heat can be applied as described above.

FIG. 2 is a cross-sectional view of a first exemplary embodiment of a paper-constructed object according to this invention formed using the fiber-powder paper described above. As shown in FIG. 2, the paper-constructed object comprises an upper or top layer or sheet 4 of the fiber-powder paper, a lower or bottom layer or sheet 5 of the fiber-powder paper, and an interposed middle layer or sheet 6 of the fiber-powder paper. The middle layer or sheet 6 has a plurality of projections, protuberances, distensions, bulges, protrusions or deformations that extend between the upper or top layer or sheet 4 and the lower or bottom layer or sheet 5 of the fiber-powder paper.

In various exemplary embodiments, these projections, etc. have a square cross-sectional shape, when viewed along a plane that is parallel to the upper and lower sheets 4 and 5. In various exemplary embodiments, the side surfaces of the projections, etc. are equilateral triangles, such that the projections, etc. form equilateral 4-sided pyramids. However, it should be appreciated that other shapes for the projections, etc. can be used, such as non-equilateral pyramids, tetrahedrons, equilateral tetrahedrons, higher order polyhedrons, semispherical shapes and the like. In various exemplary embodiments, adjacent ones of the projections, etc. share bottom edges, such that there are no gaps or the like in the middle layer or sheet 6. It should be appreciated that the equilateral 4-sided pyramid is a mechanically strong structure, as are the other structures outlined above. Thus, it should be appreciated that, while the following detailed description refers particularly to 4-sided equilateral pyramids, any of these alternatives could be used, and this term should be understood to encompass any appropriate shape for the projections, etc. Thus, it should be appreciated that, in the following detailed description, the term “equilateral 4-sided pyramidal projection, etc.” is used generically to refer to all such variations, even if such variations are not equilateral, are not 4-sided and/or are not mathematically pyramidal shaped.

In various exemplary embodiments, the equilateral 4-sided pyramidal projections, etc. formed in the middle layer or sheet 6 are formed by press forming the middle layer or sheet 6. Thus, the equilateral 4-sided pyramidal projections, etc. do not have bottom surfaces provided by the middle layer or sheet 6. As shown in FIG. 2, the equilateral 4-sided pyramidal projections, etc. that are formed or provided in the middle layer or sheet 6 have their tips bonded or adhered to the upper layer or sheet 4. Similarly, the bottom edges of the equilateral 4-sided pyramidal projections, etc. are bonded or adhered to the lower or bottom layer or sheet 5. It should be appreciated that this first exemplary embodiment of the paper-constructed object according to this invention can be used as material in paper packing boxes, such as cardboard used to form the boxes, inserts within such boxes and the like. It should be appreciated that this first exemplary embodiment of the upper-constructed object according to this invention can be used in any application where traditional cardboard can appropriately be used.

FIG. 3 is a prospective view of a portion of the equilateral 4-sided pyramidal projections, etc. that are formed or provided in the middle layer or sheet 6 of the first exemplary embodiment of the paper-constructed object shown in FIG. 2. In particular, FIG. 3 illustrates one exemplary embodiment for how the plurality of pyramidal projections, etc. formed or provided in the sheet or layer 6 can be arrayed or arranged.

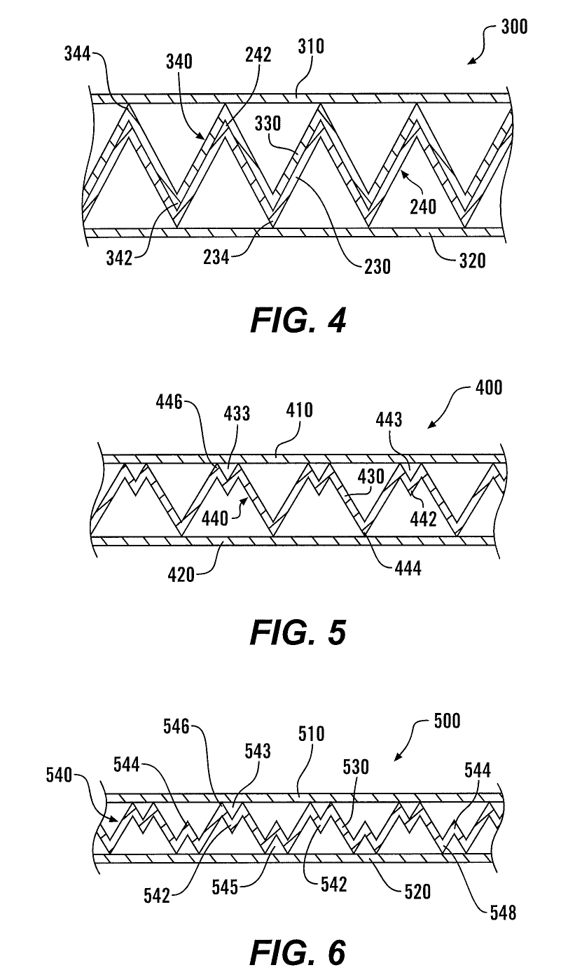

FIG. 4 is a cross-sectional view of a second exemplary embodiment of a paper-constructed object according to this invention formed using the sheets of the fiber-powder paper shown in FIG. 1. As shown in FIG. 4, the second exemplary embodiment of the paper-constructed object has a second, opposing middle layer or sheet 7 of the fiber-powder paper. This second middle layer or sheet 7 also has a plurality of equilateral 4-sided pyramidal projections, etc. This second middle layer or sheet 7 is arranged relative to the first middle layer or sheet 6 so that it intermeshes with the first middle layer or sheet 6 of the fiber-powder paper.

In various exemplary embodiments, the base side of the middle layer or sheet 6 of the fiber-powder paper is bonded or adhered to the inner surface of the lower layer or sheet 5 of the fiber-powder paper. At the same time, the base side of the second middle layer or sheet 7 of the fiber-powder paper is bonded or adhered in the same manner to the inner surface of the upper layer or sheet 4 of the fiber-powder paper. The first and second middle layers or sheets 6 and 7 are then bonded or adhered to each other in a mutually intermeshing fashion so that the projections of one sheet extend between the projections of the other sheet and the tips of each of the projections of the first and second middle layers or sheets 6 and 7 are located adjacent to the base edges of the projections of the other one of the first and second middle layers or sheets 6 and 7, respectively.

It should be appreciated that, in the first exemplary embodiment of the paper-constructed object shown in FIG. 2, there is the potential for a folding bend to occur wherever the base edges of a row or column of the equilateral 4-sided pyramidal projections, etc. contact the bottom sheet or layer 5 of the fiber-powder paper. However, in the second exemplary embodiment of the paper-constructed object shown in FIG. 4, a folding bend is unlikely to occur at such location, because the second middle layer or sheet 7 tends to reinforce or sufficiently strengthen those areas in the first middle layer or sheet 6, and vice versa. That is, the tip of one of the equilateral 4-sided pyramidal projections is intermeshed with and adjacent to one or more of the base edges of one or more of the equilateral 4-sided pyramidal projections, etc. on the other middle layer or sheet 6 or 7, and vice versa, such that a bend is unlikely to occur in such areas.

FIG. 5 is a cross-sectional view of a third exemplary embodiment of the paper-constructed object according to this invention that uses the fiber-powder paper shown in FIG. 1. As shown in FIG. 5, this third exemplary embodiment of the paper-constructed object has an upper layer or sheet 4 of the fiber-powder paper and a lower layer or sheet 5 of the fiber-powder paper, with a middle layer or sheet 8 of the fiber-powder paper extending between the upper or lower layers or sheets 4 and 5 of the fiber-powder paper. As shown in FIG. 5, at least some of the equilateral 4-sided pyramidal projections, etc. of the middle layer or sheet 8 of the fiber-powder paper have a depression 10 formed in the tips, such that the tips point downward toward the bottom layer or sheet 5 of the fiber-powder paper. At the same time, the upper edges of the depression 10 contact the upper layer or sheet 4 of the fiber-powder paper. The depressions 10 provide a stronger structure against stress. The depressions 10 also increase the bonding or adhesion area for bonding or adhering the upper layer or sheet 4 of the fiber-powder paper to the middle layer or sheet 8 of the fiber-powder paper, making it more difficult for the upper layer or sheet 4 of the fiber-powder paper to peel off from, or delaminate from, the middle layer or sheet 8 of the fiber-powder paper.

FIG. 6 is a cross-sectional view of a fourth exemplary embodiment of a paper-constructed object according to this invention that uses the fiber-powder paper shown in FIG. 1. As shown in FIG. 6, in addition to, or, alternatively, in place of, the depressions 10 formed in the tips of the equilateral 4-sided pyramidal depressions, etc., a plurality of depressions 11 may also be formed in the base side of the three-dimensional middle layer or sheet 6, that is, the connecting edges between neighboring ones of at least some of the equilateral 4-sided pyramidal projections, etc. are provided with the depressions 11 such that the base edges now project toward the upper or top layer or sheet 4 of the fiber-powder paper. Like the depressions 10, the depressions 11 provide this fourth exemplary embodiment of the paper-constructed object with additional strength to resist various deforming stresses.

Moreover, also similarly to the depressions 10, the depressions 11 also increase the bonding or adhesion area for bonding or adhering the lower or bottom layer or sheet 5 of the fiber-powder paper to the base side of the middle layer or sheet 6, thus making it more difficult for the lower or bottom layer sheet 5 of the fiber-powder paper to peel off from, or delaminate from, the base side of the middle layer or sheet of paper 6. Thus, these additional depressions further strengthen this fourth exemplary embodiment of the paper-constructed object, such that it is stronger against additional high stresses.

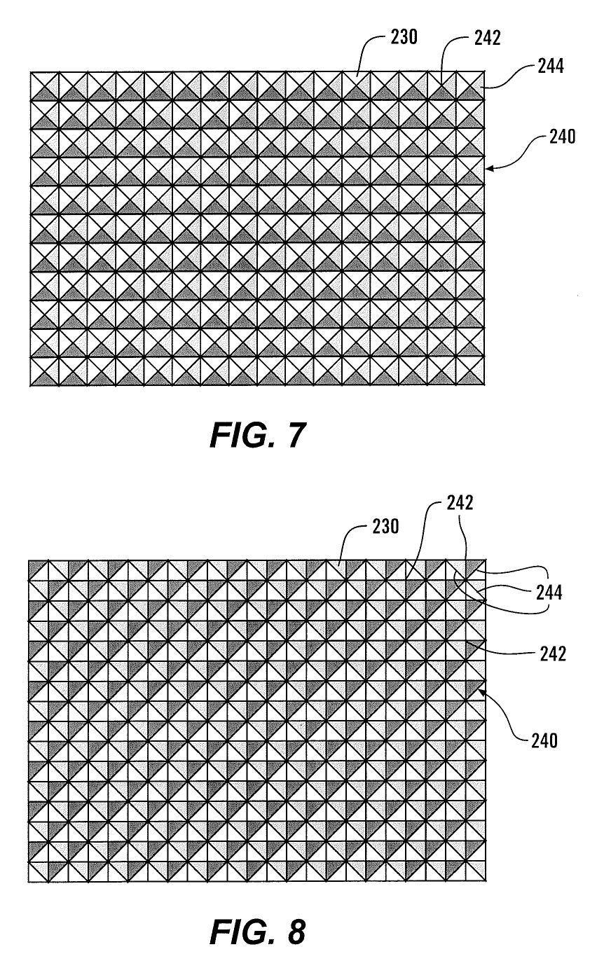

FIG. 7 is a top plan view illustrating a first exemplary arrangement of the plurality of equilateral 4-sided pyramidal projections, etc. formed in the first or second middle layers or sheets 6-8. As shown in FIG. 7, in various exemplary embodiments, the equilateral 4-sided pyramidal projections, etc. are formed by press-forming a sheet of the fiber-powder paper shown in FIG. 1. In particular, in various exemplary embodiments, the projections, etc. are formed without gaps between adjacent ones of the projections, etc. As shown in FIG. 7, in various exemplary embodiments, the projections, etc. are arranged in the sheet of fiber-powder paper so that the projections, etc. are parallel to each edge of the upper or top layer or sheet 4 and/or the lower or bottom layer or sheet 5 of the fiber-powder paper and/or at an angle to each edge of the middle sheet or layer 6-8.

FIG. 8 is a top plan view of a second exemplary arrangement of the plurality of equilateral 4-sided pyramidal projections, etc. formed in the first or second middle layers or sheets 6-8. As shown in FIG. 8, in this second exemplary arrangement, the projections, etc. formed in the sheet of fiber-powder paper are positioned at an angle relative to the edges of the upper or top layer or sheet 4 and/or the lower or bottom layer or sheet 5 and/or at an angle to each edge of the middle sheet or layer 6-8. In the second exemplary arrangement shown in FIG. 8, the equilateral 4-sided pyramidal projections, etc. are arranged in a square array that is at a 45° angle relative to the edges of the upper or top layer or sheet 4 and/or the lower or bottom layer or sheet 5 of the fiber-powder paper and/or to the edges of the middle sheet or layer 6-8.

It should be appreciated that the array of projections, etc. can be arranged at any desired angle relative to the edges of the sheet or layer of the fiber-powder paper used to form the middle layer or sheet 6 or 7. Likewise, it should be appreciated that the array of projections, etc. can be arranged at any desired angle relative to the edges of the upper or top layer or sheet 4 and/or the lower or bottom layer or sheet 5 of the fiber-powder paper. It should further be appreciated that the plurality of projections, etc. do not need to be arranged in a square array, i.e., arranged in an array of rows and columns. Rather, the plurality of projections, etc. can be arranged such that adjacent rows or columns are offset relative to each other, instead of, or in addition to, being rotated relative to the edges of the various sheets of the fiber-powder paper used to implement the layers 4-8 of the paper-constructed object. Additionally, two different sizes of projections can be included in the arrangement of projections formed in the middle layer or sheet 6-8. In this case, the larger projections can include one or both of the depressions 10 or 11, such that the larger projections have the same vertical height or extent as the smaller projections.

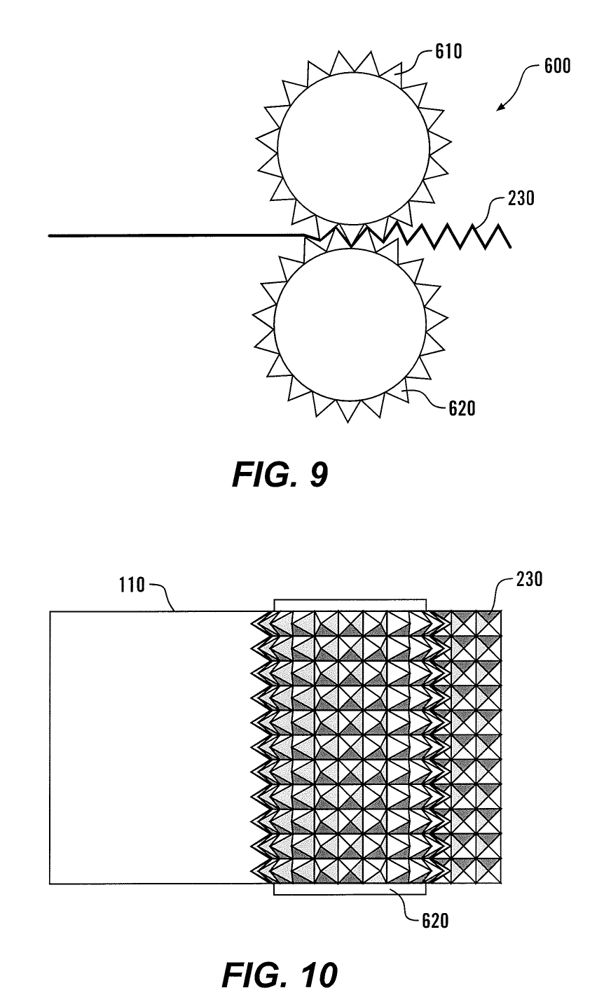

In various exemplary embodiments, the middle layer or sheet 6, 7 or 8 used in the various exemplary embodiments of the paper-constructed object discussed above is formed by press forming using one or more rollers. FIG. 9(a) is a side schematic view of one exemplary embodiment of a pair of rollers 20 and 21 usable to shape and press-form the middle layer or sheet 6, 7 and/or 8. FIG. 9(b) is a top perspective view of one exemplary embodiment of the roller 20 and the middle layer or sheet 6 or 7 formed using this roller 20 and a complimentary or corresponding roller 21. In particular, in the embodiment shown in FIG. 9(b), the corresponding roller 21 will have a plurality of correspondingly-shaped depressions or pits that the projections on the roller 20 will extend into as the rollers 20 and 21 rotate relative to each other. The projections on the roller 20 push the fiber-powder paper of the sheet of fiber-powder paper being fed to the rollers 20 and 21 into the depressions or pits on the roller 21 to form the projections, etc. in the layers or sheets 6-8.

A shown in FIG. 9(b), the orthogonal cross-sectional shape of the projections formed on the roller 20 is a square and the side surfaces of the projections are equilateral triangles. The equilateral 4-sided pyramidal projections thus formed are arranged on the roller 20 without gaps between adjacent ones of the projections. As indicated above, the layers or sheets 6-8 can be formed by passing the fiber-powder paper product shown in FIG. 1 through the space between the rollers 20 and 21, as shown in FIG. 9(a).

In the above-outlined exemplary embodiments, the middle layer or sheets 6-8 are formed by press forming using one or more rollers. However, forming the middle layers or sheets 6-8 is not limited to this process. Rather, in various other exemplary embodiments, the middle layers or sheets 6-8 can be formed by pouring a liquid or slurry mixture usable to make the fiber-powder paper product into a mold. In various exemplary embodiments, the mold can have an orthogonal cross-sectional shape of a square and the side surfaces can be equilateral triangles to create a sheet of the fiber-powder paper having a plurality of equilateral 4-sided pyramidal projections.

In various exemplary embodiments, the liquid material can be formed by mixing powdered agricultural and/or forestry product fibers and/or powdered recycled paper product fibers together with a loosened biodegradable plastic material, which retains its fibers, into a mold having an arrangement of a plurality of equilateral 4-sided pyramidal projections or depressions. The mixture or slurry can then be allowed to dry. Upon removing the dried mixture or slurry from the mold, a resulting sheet of fiber-powder paper corresponding to the layers or sheets 6-8 can be obtained. In this manner, a middle layer or sheet 6-8, where the orthogonal cross-sectional shape is a square and the side surfaces are equilateral triangles, such that the projections, etc. are equilateral 4-sided pyramidal shapes, is obtained. It should further be appreciated that the sheets 6-8 can be made using any other known or later-developed appropriate process.

The various exemplary embodiments of the paper-constructed object shown in FIGS. 2 and 4-6 can be manufactured using a variety of methods. In one exemplary embodiment of a batch method, precut sheets of the fiber-powder paper can be passed through a pair of the rollers 20 and 21 to form a sheet 6. The rollers 20 and 21 can be operated by muscle power. The muscle power can be provided by an animal or by a human operator. Subsequently, precut corresponding upper layers or sheets 4 and lower layers or sheets 5 can be brought together above and below the sheet 6 and appropriately bonded and/or adhered together to form the paper-constructed object. In various exemplary embodiments, the bonding or adhesive agent can be sprayed or spread onto either the inner surfaces of the upper and lowers or sheets 4 and 5 and/or on the top and bottom surfaces of the middle layer or sheet 6. It should be appreciated that this first exemplary embodiment of a batch method can also be used as outlined above to form the second exemplary embodiment of the paper-constructed object shown in FIG. 4. Further, when appropriate rollers 20 and 21 are used, this first exemplary embodiment of a batch method can be used to form the paper-constructed objects shown in FIGS. 5 and/or 6.

Alternatively, in a first exemplary embodiment of a continuous process, three or more preformed rolls of the fiber-powder paper shown in FIG. 1 can be brought together. One or more middle sheets of the fiber-powder paper can be provided directly from the rolls to a corresponding number of one or more sets of rollers 20 and 21 to form the first and/or second middle layers 6-8. The one or more middle sheets or layers 6, 7 and/or 8 can then be brought together with a first sheet forming the upper or top layer or sheet 4 and a second sheet forming the bottom or lower layer or sheet 5, along with one or more appropriate bonding or adhesive agents. The various sheets are brought together with the various bonding and/or adhesive agents to form a continuous sheet of the paper-constructed object shown in FIG. 2, 4, 5 or 6. Subsequently, depending on the desired use, the continuous sheet of the paper-constructed object can be cut in a variety ways to form individual sheets, forms or panels of the paper-constructed object. In various exemplary embodiments, the sheets or forms can be bent in a variety of ways to form boxes, inserts, dividers or any other object that is appropriately formed using the paper-constructed object shown in FIGS. 2 and 4-6 according to this invention.

Finally, in various exemplary embodiments of a fully-automated process, the various materials usable to form the sheet of fiber-powder paper shown in FIG. 1 can be provided to three distinct fiber-powder paper forming devices or apparatus. Each of the three fiber-paper forming devices or apparatus outputs a continuous sheet of the fiber-powder paper shown in FIG. 1. Then, rather than gathering the sheet of fiber-powder paper into a roll, a middle one or more of the sheets, after being formed, can be fed to a corresponding number of one or more rollers to convert each of the one or more sheets of fiber-powder paper into the middle layer or sheet 6, 7 and/or 8. Then, like the continuous embodiment outlined above, the one or more middle sheets 6, 7 and/or 8 are brought together, along with a top or upper layer or sheet 4 and a bottom or lower or sheet 5, along with one or more appropriate bonding agents and/or adhesives. As outlined above, the various sheets, along with the one or more bonding agents, are put together to form the paper-constructed object outlined above with respect to FIGS. 2 and 4-6.

It should be appreciated that, depending on how the materials used to form the fiber-powder paper sheets shown in FIG. 1 are processed, the fiber-powder paper sheets can have various properties, such as various degrees of water resistance, oil resistance, air permeability and/or air tightness, rigidity, hardness, tensile strength and the like. It should further be appreciated that in addition to, or in place of, forming the paper-constructed objects shown in FIGS. 2 and 4-6 into cardboard boxes and other packing materials, the paper-constructed objects, depending on how they have been processed, can be suitably used as wall panels and other products that advantageously use its multi-directional weight tolerance and strength.

Various exemplary embodiments of paper-constructed objects according to this invention provide a strong construction object that can be obtained even though the paper product it is formed out of does not have substantial strength. Furthermore, since a paper product that uses agricultural and/or forestry fiber materials and/or recycled paper product fiber materials can be easily manufactured to provide a desired or controllable degree of water permeability or resistance, and likewise can be easily manufactured to provide a desired or controllable degree of air permeability/air tightness, it becomes possible to provide a variety of properties in conjunction with the use of various exemplary embodiments of paper-constructed objects according to this invention as a paper packing box. Moreover, since various exemplary embodiments of paper-constructed objects according to this invention may not use any polluting additives, disposal of structures or objects formed using various exemplary embodiments of paper-constructed objects according to this invention is easy and friendly to the environment.

While this invention has been described in conjunction with the exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of the invention. Therefore, the invention is intended to embrace all known or later-developed alternatives, modifications variations, improvements, and/or substantial equivalents.

What is claimed is:

1. A paper-constructed object that uses a fiber-powder paper product, the fiber-powder paper product comprising a biodegradable plastic base material and a fiber-powder surface coating material applied to at least one surface of the biodegradable plastic base material, the paper constructed object comprising:
an upper sheet of the fiber-powder;
a lower sheet of the fiber-powder; and
a middle sheet of the fiber-powder paper arranged between the upper and lower sheets, the middle sheet having a plurality of contiguous projections extending between the upper and lower sheets.

2. The paper-constructed object of claim 1, wherein each of at least some of the projections has a square cross-sectional shape along a plane that is parallel to the upper and lower sheets.

3. The paper-constructed object of claim 2, wherein each of at least some of the projections has side surfaces that are equilateral triangles.

4. The paper-constructed object of claim 3, wherein each of at least some of the projections is an equilateral 4-sided pyramidal projection, each equilateral 4-sided pyramidal projection having a base having 4 edges and a tip.

5. The paper-constructed object of claim 4, wherein the four edges of the base of each equilateral 4-sided pyramidal are bonded or adhered to at least one of the upper and lower sheets.

6. The paper-constructed object of claim 5, further comprising a viscous vegetable liquid that bonds or adheres the middle sheet to at least one of the upper and lower sheets.

7. The paper-constructed object of claim 4, wherein, for at least some of the projections, for each such projection, the tip of that equilateral 4-sided pyramidal projection is depressed toward the base of that projection.

8. The paper-constructed object of claims 4, wherein, for at least some of the equilateral 4-sided pyramidal projections, for each such pair of adjacent projections, a common base edge of that pair of adjacent projections is depressed toward the tips of those projections.

9. The paper-constructed object to claims 4, wherein the plurality of equilateral 4-sided pyramidal projections are arranged so that the base edges of the projections are parallel to edges of the middle sheet.

10. The paper-constructed object of claims 4, wherein the plurality of equilateral 4-sided pyramidal projections are arranged so that the base edges of the projections are angled relative to the edges of the middle sheet.

11. The paper-constructed object of claim 1, wherein the biodegradable plastic base material has an upper surface and a lower surface, and the fiber-powder surface coating material is applied to each of the upper surface and the lower surface.

12. The paper-constructed object of claim 1, wherein the fiber-powder surface of coating material comprises a fiber-powder material obtained from at least one of:
an agricultural material,
a forestry product material, and
a recycled paper material.

13. The paper-constructed object of claim 12, wherein the agricultural material is at least one of sugar cane, hemp, kenaf, corn stalk, cotton seed shell, corn leaf, corn husk, wheat, straw, pineapple leaf, banana stem, banana leaf, and hazel nut shell.

14. The paper-constructed object of claim 1, wherein the fiber-powder surface coating material comprises a powder of fibers, the fibers having insufficient length to mechanically or frictional link together to form a felt or web of the fiber-powder surface coating material.

15. The paper-constructed object of claim 1, further comprising a second middle layer having a plurality of contiguous projections that extend between the upper and lower sheets, wherein:
base edges of at least some of the projections of the middle sheet are bonded or adhered to the upper sheet;
base edges of at least some of the projections of the second middle sheet are bonded or adhered to the lower sheet; and
the projections of the second middle sheet mutually intermesh with the projections of the middle sheet.

16. A method for manufacturing a paper-constructed object that uses a fiber-powder paper product, the fiber-powder paper product comprising a biodegradable plastic base material and a fiber-powder surface coating material applied to at least one surface of the biodegradable plastic base material, the method comprising:
press-forming a plurality of projections in a middle sheet using at least one roller having projections corresponding to a shape of the projections to be formed in the middle sheet;
bonding the top sheet to a top surface of the middle sheet; and
bonding the bottom sheet to a bottom surface of the middle sheet.

17. The method of claim 16, wherein the projections formed in the middle sheet have a square cross-sectional shape along a plane parallel to top and bottom sheets and side surfaces that are equilateral triangles, such that the projections are equilateral 4-sided pyramids.
